(19) United States
(12) Patent Application Publication
(10) Pub. No.: US 2003/0160345 A1
(43) Pub. Date: Aug. 28, 2003

(54) Back pressure control method of injection molding machine driven by servo motor

(76) Inventors: Hsing-Chang Liu, Hsinchu (TW); Ken-Hsien Lai, Hsinchu (TW); Han-Chieh Chang, Taipei (TW); Yu-Chu Hsu, Chu-Pie (TW)

Correspondence Address: RABIN BERDO, P.C., Suite 500, 1101 14 Street, N.W., Washington, DC, 20005, US

(21) Appl. No.: 10/079,419

(22) Filed: Feb. 22, 2002

(51) Int. Cl. B29C 45/76

(52) U.S. Cl. 264/40.5; 264/328.1

(57) ABSTRACT

A back pressure control method of a servo-driven injection molding machine is proposed, wherein the injection molding machine includes a metering servo and an injection servo motor, which is controlled by a current circuit, a position circuit, a speed circuit and corresponding controllers thereof, so as to perform multi-stage metering control of back pressure. The back pressure control method includes the steps of: establishing a current-pressure relationship table according to mechanism design of the injection molding machine and torque values of the injection servo motor; setting a back pressure value and a rotation speed of the metering servo motor for each metering position; retrieving a current value corresponding to a maximal set value of back pressure according to the current-pressure relationship table, so as to obtain a torque upper-limit value outputted by the injection molding machine; and setting output from a position controller of the position circuit to be zero.

### FIELD OF THE INVENTION

The present invention relates to back pressure control methods of injection molding machines driven by servo motors, and more particularly, to a multi-stage metering method of a back pressure for accurately controlling a servo-driven injection molding machine.

### BACKGROUND OF INVENTION

In a metering process for an injection molding machine, a plastic material such as resin is plasticized and melted by rotating a screw in a heating cylinder, and the melted resin is temporarily stored at an end portion of the heating cylinder. The screw is driven to move backwards by a pressure generated in the plasticizing of the melted resin. When the screw moves to a predetermined metering position, the screw stop rotating, and the metering process terminates.

Generally, in order to modulate the resin melting and metering effect, a back pressure of the screw is necessarily controlled in the metering process. For example of a hydraulically-driven injection molding machine, a back pressure thereof is also controlled by a hydraulic mechanism. However, in such a conventional injection molding machine, hydraulic oil used therein is inherent with a problem of transmission impedance due to its compressibility and viscousness, making resin plasticizing and metering accuracy adversely affected. This results in poor quality assurance of molded products, and undesirably damages machine functionality.

Therefore, the present invention provides an advanced back pressure control method of an injection molding machine driven by servo motors, in which maneuverability and controllability of a servo-driven mechanism are adopted in favor of overcoming the above drawbacks in a conventional hydraulic mechanism.

### SUMMARY OF THE INVENTION

A primary objective of the present invention is to provide a back pressure control method of an injection molding machine driven by servo motors, in which an injection servo motor and a metering servo motor are respectively used for injection and metering control, making the back pressure control method more accurate, efficient and sensitive to implement.

Another objective of the invention is to provide a back pressure control method of an injection molding machine driven by servo motors, which can eliminate drawbacks of using a conventional hydraulic method for back pressure control, and improve operational accuracy and functionality of the injection molding machine, making quality assurance of molded products well maintained.

In accordance with the foregoing and other objectives, the present invention proposes a back pressure control method of an injection molding machine driven by servo motors. The injection molding machine comprises: a metering servo motor for rotating a screw in a metering axis, and an injection servo motor for driving the screw to move in an injection axis and for performing injection, wherein the injection servo motor is controlled cooperatively by a current circuit, a position circuit, a speed circuit and corresponding controllers thereof, so as to perform multi-stage metering control of back pressure. The back pressure control method of the invention comprises the steps of: establishing a current-pressure relationship table according to mechanism design of the injection molding machine and torque values of the injection servo motor; setting a back pressure value and a rotation speed of the metering servo motor for each metering position; retrieving a current value corresponding to a maximal set value of back pressure according to the current-pressure relationship table, so as to obtain a torque upper-limit value outputted by the injection molding machine; and setting output from a position controller of the position circuit to be zero.

### BRIEF DESCRIPTION OF THE DRAWINGS

The present invention can be more fully understood by reading the following detailed description of the preferred embodiments, with reference made to the accompanying drawings wherein:

FIG. 1 is a schematic block diagram showing a back pressure control system of an injection molding machine according to a preferred embodiment of the invention; and

FIG. 2 is a flowchart showing the steps involved in a metering process of the invention.

### DETAILED DESCRIPTION OF THE PREFERRED EMBODIMENT

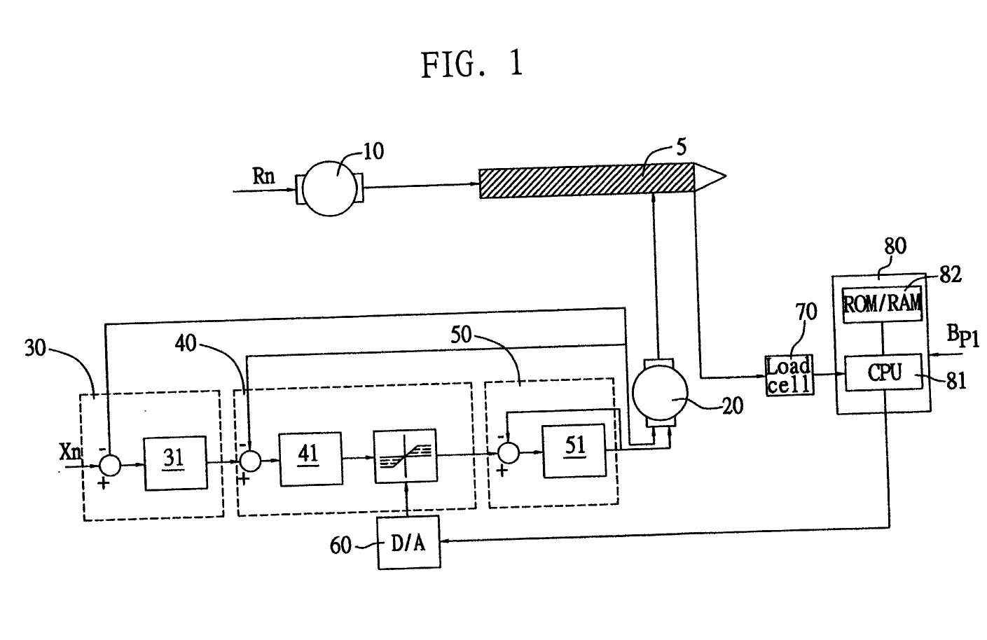

FIG. 1 illustrates a schematic block diagram showing a back pressure control system of an injection molding machine according to a preferred embodiment of the present invention. As shown in the drawing, the injection molding machine comprises: a metering servo motor 10 for rotating a screw 5 in a metering axis, and an injection servo motor 20 for driving the screw 5 in an injection axis; which injection molding machine 100 applies a back pressure on the screw 5 in operation of injection and metering processes. The metering servo motor 10 and the injection servo motor 20 can be respectively provided with a pulse counter (not shown) for indicating and measuring position and speed thereof.

A position circuit 30 with a position controller 31, a speed circuit 40 with a speed controller 41, and a current circuit 50 with a current controller 51 are cooperatively used to control the injection servo motor 20, so as to perform multi-stage back pressure control.

During the metering process, regardless of friction and acceleration effect, a pressure applied at a front end of a loading tube should be nearly equal to a torque force outputted from the injection servo motor 20. A forward injection direction of the screw 5 is customarily referred to as a positive direction; in reverse, a backward direction of the screw 5 is referred to as a negative direction. Therefore, in order to control a pressure of an injected plastic material such as resin, firstly, an output torque force from the injection servo motor 20 must be maintained as a constant, and a torque output direction of the injection servo motor 20 is set at the positive direction of the screw 5. Then, a torque-pressure relationship table is simply established according to the mechanism design of the injection molding machine 100 and output torque values of the injection servo motor 20. Alternatively, as shown in the drawing, the injection servo motor 20 can be electrically connected to a load cell 70, whereby feedback of the load cell 70 is used to estimate values of back pressure (kg/cm²) corresponding to various torque forces outputted from the injection servo motor 20. These obtained data relating to motor torque and back pressure can be converted to a current-pressure relationship table by a processor 81 e.g. CPU (central processing unit) in a data manipulation circuit 80, which current-pressure relationship table is stored in a memory 82 such as ROM or RAM.

Subsequently, a back pressure value and a rotation speed of the metering servo motor 10 are set for each metering position, as shown in Table 1. As the metering servo motor 10 rotates to introduce the plastic resin and accordingly generates a pressure for driving the screw 5 to move backwards in an injection axis, various metering position in accompany with corresponding metering rotation speeds can be taken into account for estimating an optimal back pressure value.

TABLE 1

| | | | | | |
|---|---|---|---|---|---|
| Position | X1 | X2 | X3 | . . . | Xn |
| Metering rotation speed | R1 | R2 | R3 | . . . | Rn |
| Upper-limit torque in an injection axis (%) | T1 | T2 | T3 | . . . | Tn |

Next, the current-pressure relationship table is adopted to obtain a current value corresponding to a maximal back pressure value set in Table 1, allowing a torque force generated through the use of the obtained current value, to be defined as a torque upper-limit value of the injection servo motor 20.

Finally, the position controller 31 is set with a command of output current being zero. As positioning errors accumulate proportionally with backward movement of the screw 5, positive speed commands (at the injection direction) responsively keep increased. Thereby, once a metering terminal point is reached, the metering servo motor 10 stops injecting the plastic resin, and the injection servo motor 20 returns to normal torque setting. As a result, positive speed commands remained in an injection servo circuit completely act on the injection-axis movement of the screw 5, leading to instability of back pressure control.

As shown in FIG. 1, when the screw 5 is held at a position Xn (n=1, 2, 3 . . . , the processor 81 prompts the metering servo motor 10 to output a set rotation speed Rn, and a corresponding current value for a set value of back pressure Bpn is retrieved by using the current-pressure relationship table stored in the memory 82. Then, the retrieved current value is converted into a first voltage analog signal by a digital/analog (D/A) signal converter 60, which first voltage analog signal is inputted to the speed circuit 40 of the injection servo motor 20. In respect of the above circuits for controlling the injection servo motor 20, the position controller 31 of the position circuit 30 receives a position command of a metering position being X1, which is added up with a position feedback value from the screw 5 to generate a speed command. The speed command plus a speed feedback value from the screw 5 is inputted to the speed controller 41 of the speed circuit 40 so as to produce a second voltage signal. If the second voltage signal is not sufficient for driving the screw 5 to move in the positive direction, a current command inputted to the current controller 51 would be quickly increased up to a saturate voltage value limited by the first voltage analog signal, and then can be inputted to the injection servo motor 20.

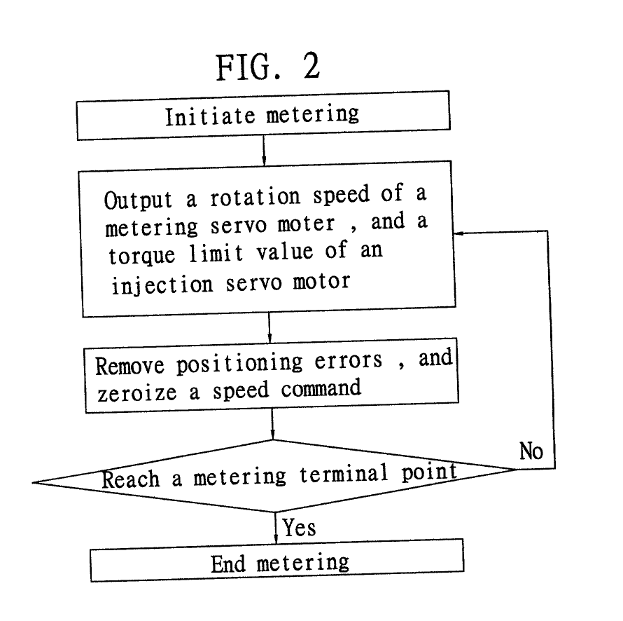

Referring to FIG. 2, it illustrates a flowchart showing the steps involved in a metering process of the invention. The first step is to initiate metering control. According to Table 1, a rotation speed of the metering servo motor 10 and a set value of back pressure are outputted and processed by the processor 81 to obtain a corresponding current value. The obtained current value is inputted to the digital/analog signal converter 60 and converted to a first voltage analog signal. The first voltage analog signal is in turn inputted to a circuit of the injection servo motor 20, so as to set a current upper limit of the injection servo motor 20. When load of the plastic resin is greater than the current upper limit of the injection servo motor 20, the screw 5 is forced to move backwards; in the meantime, a feedback current is of a constant value. Then, positioning errors produced by the backward movement of the screw 5 are zeroized, allowing a speed command outputted from the position circuit 40 to become zero. The foregoing process of back pressure control would continue until reaching a metering terminal point.

In a metering process for an injection molding machine driven by servo motors, a back pressure value can be easily controlled in conditions that, a current command is controlled at a constant value, and a current flow is set in a positive direction. However, if the entire circuit for an injection servo motor purely operates with a current command mode, a processor is not able to promptly control feedback values of position and speed, thereby leading to problems of speed loss and positioning inaccuracy of a screw. Therefore, instead of direct current command control, the back pressure control method of the invention adopts servo circuit control of three closed circuits and torque limit control for the injection servo motor, so as to constantly maintain an operating current for the injection motor, in favor of desirably achieving the back pressure control.

The back pressure control method of an injection molding machine driven by servo motors of the invention is advantageous of being more accurate, efficient and sensitive to implement, and can improve operational accuracy and functionality of the injection molding machine, making quality assurance of molded products well maintained.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A back pressure control method of an injection molding machine driven by servo motors, which injection molding machine includes a metering servo motor for rotating a screw in a metering axis, and an injection servo motor for driving the screw to move in an injection axis and for performing injection, wherein the injection servo motor is controlled cooperatively by a current circuit, a position circuit, a speed circuit and corresponding controllers thereof, so as to perform multi-stage metering control of back pressure; the back pressure control method comprising the steps of:
(a) establishing a current-pressure relationship table according to mechanism design of the injection molding machine and torque values of the injection servo motor;
(b) setting a back pressure value and a rotation speed of the metering servo motor for each metering position;
(c) retrieving a current value corresponding to a maximal set value of back pressure according to the current-pressure relationship table, so as to obtain a torque upper-limit value outputted by the injection molding machine; and
(d) setting output from a position controller of the position circuit to be zero.

2. The back pressure control method of claim 1, further comprising a step of:
converting the retrieved current value to a first voltage analog signal by a digital/analog signal converter according to the current-pressure relationship table.

3. The back pressure control method of claim 1, wherein the position controller of the position circuit is used to generate a speed command, which speed command is added up with a speed feedback value from the screw, and in turn inputted to a speed controller of the speed circuit.

4. The back pressure control method of claim 2, wherein when a second voltage signal generated by a speed controller of the speed circuit is insufficient for driving the screw to move in a positive direction, a current inputted to a current controller of the current circuit is quickly increased up to a saturate current value limited by the first voltage analog signal, and in turn inputted to the injection servo motor.

5. The back pressure control method of claim 4, wherein the positive direction is a forward injection direction of the screw.

6. The back pressure control method of claim 4, wherein the positive direction of the screw is a reverse direction with respect to a forward injection direction.

7. The back pressure control method of claim 1, wherein the injection servo motor is electrically connected to a load cell, allowing estimated feedback values of back pressure for the load cell to be used in establishing the current-pressure relationship table.
